(19) United States
(12) Patent Application Publication
(10) Pub. No.: US 2004/0225079 A1
(43) Pub. Date: Nov. 11, 2004

(54) Erosion-resistant silicone coatings

(75) Inventors: Karl Erik Wiedemann, Seaford, VA (US); Rajagopalan Sivakumar, Yorktown, VA (US); Bridget Marion Sanders, Warren, MI (US)

Correspondence Address: JOY L BRYANT, P O BOX 590, LIGHTFOOT, VA, 23090

(73) Assignee: Analytical Services and Materials Inc., Hampton, VA

(21) Appl. No.: 10/429,238

(22) Filed: May 5, 2003

(51) Int. Cl. C08G 77/00

(52) U.S. Cl. 525/477

(57) ABSTRACT

Novel erosion-resistant silicone coatings can include an acetoxylated silane, an alkoxylated silane, and a silanol fluid. These erosion-resistant silicone coatings can be formed from coating compositions. The preparation of coating compositions, application of coating compositions to substrates, and uses of these coatings are also described.

### BACKGROUND OF THE INVENTION

The present invention relates to the use of erosion-resistant silicone coatings for the protection of substrates, compositions for forming erosion-resistant silicone coatings, and methods of applying erosion-resistant silicone coatings to substrates. The invention also relates to curing agents.

Substrates, such as the surfaces and interiors of machine or structural parts, often require protection against wear. A material which is selected for, say its resistance to breakage by brittle fracture may not have adequate resistance to one or more kinds of wear. A coating may then be applied to the exterior of the part, in order to protect the material forming the bulk of the part from the effects of wear.

A machine or structural part may suffer wear when it is continuously rubbed against another surface at high speeds. For example, a machine tool bit may be worn down through prolonged use. To reduce such wear, the bit is often coated with a hard material.

The high-speed impact of particles may also induce wear; this process of wear is termed erosion. The erosion of rock by blown sand is well known. However, sheathing a machine or structural part with a hard surface may not provide adequate or appropriate protection against erosion by high-speed particle impact. A common problem with helicopter operation is erosion of rotors by impacting particles such as dirt, sand grains, and water droplets. This erosion may require the frequent replacement of expensive rotors, compromise aerodynamic performance, and in some cases lead to catastrophic failure of the rotor during helicopter operation. The problem of rotor erosion is of special concern to the military: operation in arid or desert environments may result in erosion at a rapid rate and the exigencies and uncertainties associated with combat may preclude regular maintenance. Presently, several approaches, none of which are fully satisfactory, are taken to protect helicopter rotors. In one approach, metal strips are fastened to the leading edge of the rotors. Metal strips are rigid and therefore compromise the aerodynamic performance of composite rotors which are designed to flex in several modes; the metal strips may place extra mechanical stress on the rotors, for example, by constraining their flexing. The metal strips can initiate small cracks in the composite material of the rotor; these cracks can then grow, resulting in catastrophic failure. Because of the problem of crack initiation, frequent, expensive inspection is required. Furthermore, the metal strips are rapidly damaged by impacting particles. Hard, brittle metal strips tend to have material chipped off by the particles and softer metal strips tend to suffer deformation.

Attempts to protect helicopter rotors have also included the use of polyurethane tape applied to the leading edge of rotors. Because the tape is flexible, it has the advantage over the metallic strips of not impeding the flexing of a composite rotor. However, the tape can trap sand beneath it, which can compromise the mass balance of rotors on opposite sides of the drive shaft and affect performance. Furthermore, the tape is rapidly abraded by impacting sand and rain droplets and requires frequent replacement. Finally, under harsh conditions, the adhesive which affixes the tape to the rotor can fail.

Hydroelectric turbines may also be eroded by impacting silt particles. Cavitation next to the surface of marine propellers may erode the surface of a propeller. A metallic coating or shield would also be eroded and could transmit vibration associated with cavitation to the propeller.

The inadequate polyurethane tape is an example of a polymer coating. Other forms of polymer materials may be considered as protective coatings. Silicone polymers have certain properties which could be advantageous in protecting substrates. For example, they are resistant to degradation by ultraviolet radiation, which is a positive characteristic for a material envisioned for coating helicopter rotors, which may be directly exposed to the sun for extended periods of time. Silicone polymers are not degraded by water, which would allow them to be used for coating hydroelectric turbines and marine propellers. However, flexible silicone polymer coatings are infrequently used in applications where they must withstand severe mechanical stress, such as imposed by high-velocity impacting particles, in protecting machine or structural parts.

U.S. Pat. No. 4,911,864 discloses an electrically conductive coating in which silicon compounds are used to support conductive materials. A large number of silicon compounds are disclosed as being suitable, including trialkoxysilanes and triacetoxysilanes. However, the specific silicon compound used and the specific polymer structure formed are of minimal importance for the materials disclosed in U.S. Pat. No. 4,911,864. Furthermore, there is no mention of specifically using two or more silane crosslinking agents in conjunction with each other.

Compositions used to prepare silicone elastomers are disclosed in U.S. Pat. No. 5,502,144. The disclosure recites the use of silane crosslinking agents to crosslink hydroxy-terminated polydimethylsiloxane. However, the disclosure teaches away from the use of acetoxylated silane compounds because it maintains that when they are used a strong odor is released and metal substrates corroded upon cure. The disclosure teaches away from the use of alkoxylated silane compounds because their use results in a slow cure. The disclosure also teaches away from the use of alkenyloxylated silanes because of their high expense and incompatibility with certain organic fillers. A long list of silane agents for crosslinking hydroxy-terminated polyorganosiloxanes is presented. Seeming to contradict the recital of limitations of acetoxylated and alkoxylated silane crosslinking agents, compounds such as vinyltriethoxysilane and vinyltriacetoxysilane are mentioned as crosslinking agents which can be used. There is no mention of specifically using two or more silane crosslinking agents in conjunction with each other.

Silicone elastomers are disclosed in the context of a printing system in U.S. Pat. No. 5,811,210. A large number of silane compounds are mentioned as suitable agents for crosslinking polyorganosiloxanes including tetramethoxysilane, tetraethoxysilane, ethyltriethoxysilane, and ethyltriacetoxysilane. However, there is no mention of specifically using two or more silane crosslinking agents in conjunction with each other.

Crosslinkable polysiloxane compositions are disclosed in U.S. Pat. No. 6,126,756. Ethyltriacetoxysilane and vinyltriethoxysilane are mentioned within a list of suitable crosslinking agents. However, there is no mention of specifically using two or more silane crosslinking agents in conjunction with each other.

There thus remains an unmet need for a coating which can effectively shield a surface from impacting particles and the effects of cavitation, is inexpensive and easy to apply, has long operating life, and is mechanically compatible with a machine or structural part, such as a flexible, composite helicopter rotor, associated with the surface.

### SUMMARY OF THE INVENTION

It is therefore the object of the present invention to provide novel erosion-resistant coatings which can effectively shield a surface from impacting particles and the effects of cavitation, are inexpensive and easy to apply, have long operating life, and are mechanically compatible with a machine or structural part associated with the surface.

Coating compositions of the present invention include an acetoxylated silane in an amount of from about 0.01 wt. % to about 95 wt. % of the composition, an alkoxylated silane in an amount of from about 0.01 wt. % to about 95 wt. % of the composition, and a silanol fluid in an amount of from about 1 wt. % to about 95 wt. % of the composition. In embodiments of the invention, the acetoxylated silane is in molar excess of the alkoxylated silane or the alkoxylated silane is in molar excess of the acetoxylated silane.

In embodiments of the invention, the silanol fluid, in an essentially pure state, has a kinematic viscosity of from about 10,000 centistokes to about 50,000 centistokes. The silanol fluid can be a hydroxy-terminated polydimethylsiloxane.

In other embodiments of the invention, the acetoxylated silane of the coating composition is an alkyl or alkenyltriacetoxysilane, wherein the alkyl or alkenyl moieties comprise more than one carbon atom, e.g., ethyltriacetoxysilane or vinyltriacetoxysilane. In embodiments of the invention, the alkoxylated silane is an alkyltrialkoxysilane, e.g., ethyltriethoxysilane, an alkenyltrialkoxysilane, e.g., vinyltriethoxysilane, or a tetraalkoxysilane, e.g., tetramethoxysilane or tetraethoxysilane.

In embodiments of the invention, the coating composition may include a catalyst, a filler, a solvent, a pigment agent, or a curing agent. The catalyst may be dibutyl tin dilaurate. The filler may be fumed silica, mica, or glass fiber. Before inclusion in the coating composition, the fumed silica may have been treated with a silica treatment agent: hexamethylenedisilazane, divinyltetramethylenedisilazane, chlorosilane, or polydimethylsiloxane. The filler may include particles of high aspect ratio.

In exemplary embodiments of the invention, the coating composition includes trimethyl terminated polydimethylsiloxane in an amount of from about 0.01 wt. % to about 30 wt. % of the composition, catalyst in an amount of from about 0.005 wt. % to about 2 wt. % of the composition, fumed silica in an amount of from 0.01 wt. % to about 30 wt. % of the composition, and mica or glass fiber in an amount of from about 0.01 wt. % to about 50 wt. % of the composition.

In exemplary embodiments of the invention, the acetoxylated silane is in the coating composition in an amount of from about 0.5 wt. % to about 8 wt. % of the composition, the alkoxylated silane is in an amount of from about 0.1 wt. % to about 4 wt. % of the composition, and the silanol fluid is in an amount of from about 40 wt. % to about 92 wt. % of the composition. Fumed silica may be in the coating composition in an amount of from about 2 wt. % to about 20 wt. % of the composition.

In exemplary embodiments of the invention, trimethyl terminated polydimethylsiloxane is included in the coating composition in an amount of from about 1 wt. % to about 4 wt. % of the composition, catalyst is in an amount of from about 0.04 wt. % to about 1 wt. % of the composition, and mica or glass fiber is in an amount of from about 0.01 wt. % to about 50 wt. % of the composition.

In exemplary embodiments of the invention, the acetoxylated silane includes ethyltriacetoxysilane in an amount of from about 1 wt. % to about 3 wt. % of the composition, the alkoxylated silane includes vinyltriethoxysilane in an amount of from about 0.1 wt. % to about 1.5 wt. % of the composition, the silanol fluid is in an amount of from about 40 wt. % to about 80 wt. % of the composition. Trimethyl terminated polydimethylsiloxane may be included in the composition in an amount of from about 2 wt. % to about 4 wt. %; catalyst may be included in an amount of from about 0.04 wt. % to about 0.08 wt. %; and fumed silica may be included in an amount of from about 2 wt. % to about 10 wt. %.

In exemplary embodiments of the invention, vinyltriacetoxysilane is included in the composition in an amount of from about 0.01 wt. % to about 3 wt. % of the composition, tetraethoxysilane is in an amount of from about 0.01 wt. % to about 3 wt. % of the composition, solvent is in an amount of from about 10 wt. % to about 60 wt. % of the composition, and mica, glass fiber, or a combination thereof is in an amount of from about 0.01 wt. % to about 50 wt. % of the composition.

In an embodiment of the invention, the molar ratio of acetoxylated silane to silanol in the coating composition is from about 10 to 1 to about 1000 to 1, and the molar ratio of acetoxylated silane to alkoxylated silane is from about 1.5 to 1 to about 8 to 1. Alternatively, the molar ratio of acetoxylated silane to silanol is from about 20 to 1 to about 250 to 1, and the molar ratio of acetoxylated silane to alkoxylated silane is from about 1.5 to 1 to about 8 to 1.

In another embodiment of the invention, the molar ratio of alkoxylated silane to silanol in the coating composition is from about 10 to 1 to about 1000 to 1, and the molar ratio of alkoxylated silane to acetoxylated silane is from about 1.5 to 1 to about 8 to 1. Alternatively, the molar ratio of alkoxylated silane to silanol is from about 20 to 1 to about 250 to 1, and the molar ratio of alkoxylated silane to acetoxylated silane is from about 1.5 to 1 to about 8 to 1.

Methods of preparing coating compositions of the present invention include providing an acetoxylated silane, providing an alkoxylated silane, providing a silanol fluid, and combining the acetoxylated silane, the alkoxylated silane, and the silanol fluid in any order and mixing.

Methods for coating a substrate with an erosion-resistant coating include preparing a coating composition for an erosion-resistant coating comprising an acetoxylated silane, an alkoxylated silane, and a silanol fluid; applying the coating composition to the substrate; and curing the coating composition on the substrate. The applying may include spraying, spreading, brushing, and dipping. The curing may include curing the coating composition in air without artificially-generated heat. In an embodiment of the invention, a period of at least two days is waited after preparing the coating composition and before applying the coating composition to the substrate.

In embodiments of the invention, a primer composition comprising an epoxy blend, an adhesion promoter, and an aliphatic amine is prepared, the primer composition is applied to the substrate, and the primer composition is at least partially cured on the substrate before applying the coating composition to the substrate. The adhesion promoter may include a trimethoxysilane, a triethoxysilane, and 3-glycidoxypropyltrimethoxysilane. The primer composition may further include a leveling agent and a solvent.

Methods for using erosion-resistant coatings of the present invention include preparing a coating composition, applying the coating composition to a part, and curing the coating composition. In exemplary embodiments of the present invention, parts such as pipes, ducts, or intake manifolds are coated. In other exemplary embodiments of the present invention, parts such as rotational units are coated. The rotational unit may be, for example, a windmill, a turbine, a helicopter rotor, an aircraft propeller, a turbojet fan, or a marine propeller.

The erosion-resistant coating composition may be used to form a coating on a surface of a part which is a metal, ceramic, or polymer material. Such materials may be, for example, a steel alloy, a stainless steel alloy, an aluminum alloy, a nickel alloy, a titanium alloy, a lead alloy, a urethane, an epoxy, a polycarbonate, an acrylic, polyester composites, epoxy composites, polyaramid fabric, polyester fabric, nylon fabric, vinyl coated fabric, glass, concrete, wood, cotton, pottery material, or brick.

Curing agent compositions of the present invention include an acetoxylated silane and an alkoxylated silane. The acetoxylated silane may be an alkyl or alkenyltriacetoxysilane having alkyl or alkenyl moieties comprising more than one carbon atom, e.g., ethyltriacetoxysilane or vinyltriacetoxysilane. The alkoxylated silane may be an alkyltrialkoxysilane, e.g., ethyltriethoxysilane, an alkenyltrialkoxysilane, e.g., vinyltriethoxysilane, or a tetraalkoxysilane, e.g., tetramethoxysilane or tetraethoxysilane.

Methods of preparing curing agent compositions of the present invention include providing an acetoxylated silane, providing an alkoxylated silane, providing a catalyst, combining the acetoxylated silane, the alkoxylated silane, and the catalyst in any order, mixing and refluxing.

Methods for using an erosion resistant coating of the present invention formed from a non-T/Q-resin forming coating composition include preparing a non-T/Q-resin forming coating composition comprising a siloxane and a crosslinking agent, applying the composition to a part, and curing the composition, to form a cured composition substantially free of T-, Q-, or TQ-resins. The part may be a pipe, a duct, an intake manifold, or a rotational unit.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other compounds can be prepared and other methods developed without parting from the spirit and scope of the invention. All references cited herein are incorporated by reference as if each had been individually incorporated.

An aspect of the invention is a composition that can be cured on a substrate to form a coating. The coating composition includes an acetoxylated silane, an alkoxylated silane, and a silanol fluid. In an embodiment, the composition further includes a catalyst. The composition may further include a filler, a solvent, a pigment, or a curing agent. The composition can be produced by mixing the components in a mixing system. Another aspect of the invention is a method for forming a protective coating on a substrate by applying the composition. In an embodiment of this method, a primer composition is applied to the substrate, allowed to partially or fully cure to form a primer, and the composition is then applied to the primer in order to form the protective coating.

Another aspect of the invention is a curing agent composition. The curing agent composition includes an acetoxylated silane and an alkoxylated silane; in an embodiment, the curing agent further comprises a catalyst.

The coating formed from the composition can be useful in protecting the substrate from degradation by the surrounding environment. For example, the coating can protect the substrate from erosion and cracking caused by impacting particles, or cavitation. The coating can exhibit long operating life under severe conditions. Such severe conditions include, for example, a large flux of impacting particles, a high kinetic energy of impacting particles, or a high density of cavitation events in the vicinity of the coating. Cavitation is the formation of small bubbles caused by a local pressure drop in a liquid below the vapor pressure of the liquid and the subsequent collapse of these bubbles; the formation and collapse of a single such bubble may be termed a cavitation event. The coatings are resistant to degradation by environmental factors such as water, temperature, and sunlight. The method of forming the coating can be simple and inexpensive and used to protect a wide range of substrate materials. Hence, another aspect of the invention is a method of using the composition. For example, the composition can be used to protect rotational units against erosion; examples of such rotational units are hydroelectric turbines and helicopter rotors.

The acetoxylated silane of the coating composition can be an alkyl or alkenyltriacetoxysilane of which the alkyl or alkenyl moiety has more than one carbon atom. For example, the acetoxylated silane can be ethyltriacetoxysilane or vinyltriacetoxysilane. The alkoxylated silane can have three or four alkoxy moities. More specifically, the alkoxylated silane can be an alkyltrialkoxysilane, e.g., ethyltriethoxysilane, an alkenyltrialkoxysilane, e.g., vinyltriethoxysilane, or a tetraalkoxysilane, e.g., tetramethoxysilane or tetraethoxysilane. In an exemplary embodiment, at least one tetraalkoxysilane is included in the composition.

The silanol fluid of the coating composition can have a kinematic viscosity of from about 10,000 centistokes to about 50,000 centistokes. The silanol fluid can be a polydialkylated siloxane, such as polydimethylsiloxane. For example, the silanol fluid can be a hydroxy-terminated polydimethylsiloxane.

A catalyst may be included in the coating composition in order to speed the curing reaction. A number of different catalysts can be used, for example, a tin catalyst can be used. An example of a useful tin catalyst is dibutyl tin dilaurate.

Inclusion of a filler in the coating composition can improve the strength of a coating which is formed. Examples of fillers include fumed silica and reinforcing agents such as mica and glass fiber. If fumed silica is used, it can be treated with an agent before addition to the rest of the coating composition. Examples of useful silica treatment agents are hexamethylenedisilazane, divinyltetramethylenedisilazane, chlorosilane, and polydimethylsiloxane. It can be advantageous to use a filler of which the particles have high aspect ratio. For example, if mica is used as a filler, mica platelets having a high square root of area to thickness ratio can be used. Similarly, if glass fibers are used, it can be advantageous to use fibers with a high length to diameter ratio. More than one type of filler can be included in the composition, for example, both fumed silica and mica can be added to the composition.

A pigment agent can be included in the composition. Such a pigment agent could, for example, improve the aesthetic appearance of the coated substrate, provide camouflage, or protect the substrate from visible or ultraviolet light. A solvent, e.g., xylene, can be included in the coating composition. The solvent may serve the function of adjusting the viscosity of the composition in order to facilitate mixing or application of the composition to a substrate.

Useful coating compositions can be formed with a wide range of fractions of the components. The fractions can be adjusted in order to form a composition tailored for a specific use. For example, the viscosity of a coating composition could be increased by decreasing the fraction of solvent in the composition. A high viscosity composition could be more useful if, for example, the composition were to be manually applied by spreading whereas a low viscosity composition could be more useful if, for example, the composition were to be sprayed onto the substrate. As another example, the hardness of the coating formed could be increased by decreasing the fraction of silanol fluid or increasing the fraction of filler in the composition.

The coating composition can include the components with fraction ranges shown in Table 1.

TABLE 1

| Component | Fraction Range |
|---|---|
| Acetoxylated silane | 0.01-95 wt. % |
| Alkoxylated silane | 0.01-95 wt. % |
| Silanol fluid | 1-95 wt. % |

Optionally, the coating composition can also include the components with fraction ranges shown in Table 2.

TABLE 2

| Component | Fraction Range |
|---|---|
| Trimethyl terminated polydimethylsiloxane | 0.01-30 wt. % |
| Catalyst | 0.005-2 wt. % |
| Solvent | 0.01-95 wt. % |
| Fumed silica | 0.01-30 wt. % |
| Mica or glass fiber | 0.01-70 wt. % |

Typically, the composition contains the acetoxy groups in molar excess of the alkoxy groups or the alkoxy groups in molar excess of the acetoxy groups.

Compositions can include fractions of components in the ranges shown in Table 3.

TABLE 3

| Component | Fraction Range |
|---|---|
| Acetoxylated silane | 0.5-8 wt. % |
| Alkoxylated silane | 0.1-4 wt. % |
| Silanol fluid | 40-92 wt. % |
| Fumed silica | 2-20 wt. % |

Optionally, these compositions can also include the components with fraction ranges shown in Table 4.

TABLE 4

| Component | Fraction Range |
|---|---|
| Trimethyl terminated | 1-4 wt. % |
| polydimethylsiloxane | |
| Catalyst | 0.04-1 wt. % |
| Solvent | 10-60 wt. % |
| Mica or glass fiber | 0.01-50 wt. % |

Exemplary compositions can include fractions of components in the ranges shown in Table 5.

TABLE 5

| Component | Fraction Range |
|---|---|
| Ethyltriacetoxysilane | 1-3 wt. % |
| Vinyltriethoxysilane | 0.1-1.5 wt. % |
| Silanol fluid | 40-80 wt. % |
| Trimethyl terminated polydimethylsiloxane | 2-4 wt. % |
| Catalyst | 0.04-0.08 wt. % |
| Fumed silica | 2-10 wt. % |

Optionally, the exemplary compositions can also include the components with fraction ranges shown in Table 6.

TABLE 6

| Component | Fraction Range |
|---|---|
| Vinyltriacetoxysilane | 0.01-3 wt. % |
| Tetraethoxysilane | 0.01-3 wt. % |
| Solvent | 10-60 wt. % |
| Mica or glass fiber | 0.01-50 wt. % |

One or more of fumed silica, mica, or glass fiber can be included in the composition. An example of a catalyst is dibutyl tin dilaurate; an example of a solvent is xylene.

The range of molar ratios of acetoxylated silane to silanol and of acetoxylated silane to alkoxylated silane in an embodiment is presented in Table 7.

TABLE 7

| Components | Range of Molar Ratios |
|---|---|
| Acetoxylated silane: Silanol | 10:1 to 1000:1 |
| Acetoxylated silane: Alkoxylated silane | 1.5:1 to 8:1 |

Exemplary embodiments can have components in the range of molar ratios as presented in Table 8.

TABLE 8

| Components | Range of Molar Ratios |
|---|---|
| Acetoxylated silane: Silanol | 20:1 to 250:1 |
| Acetoxylated silane: Alkoxylated silane | 1.5:1 to 8:1 |

The range of molar ratios of acetoxylated silane to silanol and of alkoxylated silane to acetoxylated silane in an embodiment is presented in Table 9.

TABLE 9

| Components | Range of Molar Ratios |
|---|---|
| Alkoxylated silane: Silanol | 10:1 to 1000:1 |
| Alkoxylated silane: Acetoxylated silane | 1.5:1 to 8:1 |

Exemplary embodiments can have components in the range of molar ratios as presented in Table 10.

TABLE 10

| Components | Range of Molar Ratios |
|---|---|
| Alkoxylated silane: Silanol | 20:1 to 250:1 |
| Alkoxylated silane: Acetoxylated silane | 1.5:1 to 8:1 |

Silicone materials are not very strong relative to many other polymer, ceramic, and metallic materials, so it is surprising that the silicone coatings encompassed by the invention are very resistant to erosion from, for example, particle impact and cavitation, and are very effective in protecting substrates from erosion. The erosion resistance and erosion protection provided is superior to such materials as steel, tungsten carbide, and nickel which are all considered very resistant to erosion induced by impacting solid particles, e.g., sand, or liquid particles, e.g., rain droplets. Although the prior art teaches the use of acetoxylated silanes and alkoxylated silanes as crosslinking agents, the prior art does not teach the use of acetoxylated silanes and alkoxylated silanes in combination. Embodiments of the present invention advantageously use a combination of acetoxylated silanes and alkoxylated silanes. This combination results in a coating which unexpectedly has excellent erosion resistance and has a long operating life when used to protect a substrate from the effects of particle impact and cavitation.

Without being bound by theory, it is believed that a coating formed according to the present invention protects the substrate from erosion and cracking by mechanisms similar to the following. The coating dissipates vibrational energy associated with cavitation on or near to the coated substrate as thermal energy. Therefore, the vibrational energy does not reach the substrate and cannot induce the formation of microcracks which could eventually result in catastrophic failure in the substrate. The coating also dissipates kinetic energy associated with the impact of a particle on the surface of the coating as thermal energy, and thereby stops the particle before it reaches the substrate so that the impacting particle cannot erode, chip, or deform the substrate. Because the coating absorbs vibrational as well as kinetic energy, minimal secondary vibrations are induced in the coating by an impacting particle, and secondary vibrations are not transmitted to the substrate. Furthermore, the coating is flexible, and thus does not impede the flexing of a substrate, such as a composite helicopter rotor, or impose additional mechanical stresses on a substrate which does flex.

The coating's protection of the substrate, long operating life, and flexibility are believed to result from the viscoelastic nature of the coating. Because of its viscous nature, the coating dissipates kinetic and vibrational energy as thermal energy. Because of its elastic nature, the coating is only temporarily deformed by an impacting particle and returns to its original shape within a short time.

The viscoelastic nature of the coating is believed to arise from the molecular structure of the coating. A silanol fluid may be a hydroxy-terminated polydialkyl siloxane, for example, polydimethylsiloxane chains terminated at the ends with hydroxy groups (PDMS-OH). As mentioned above, in exemplary embodiments, the kinematic viscosity of the pure silanol fluid is greater than 10,000 centistokes and can be about 50,000 centistokes. The high kinematic viscosity is believed to be a consequence of high chain molecular weight. Current understanding is that, when not subjected to stress, a silanol chain is in a random coil configuration. When subjected to stress, the chain extends, but returns to its random coil configuration when the stress is relieved.

The acetoxylated silanes and the alkoxylated silanes are believed to function as crosslinking agents; specifically, the acetoxylated silanes and the alkoxylated silanes are believed to react with the hydroxy groups on the silanol chains in the presence of moisture to form covalent bonds. Acetoxylated silanes with three acetoxy groups and alkoxylated silanes with three alkoxy groups can form covalent bonds with three chains, such that a network of chains is formed; similarly, alkoxylated silanes with four alkoxy groups can form covalent bonds with four silanol chains. After a silanol chain has reacted with acetoxylated silanes to release acetic acid, displace the hydroxy groups and bond with the acetoxylated silanes, the chain is referred to as a siloxane chain. It is believed that when a particle impacts the surface of the coating, the imposed stress temporarily deforms the coating and stretches the siloxane chains. In the process of deforming, the chains rub against each other; through friction, a portion of the energy of the impact is converted to thermal energy. This conversion to thermal energy through interchain friction accounts for the viscous nature of the coating. After the impact, the siloxane chains recoil. During the recoiling, the chains rub against each other, such that the remainder of the energy imparted to the coating through the particle impact is converted to thermal energy. During the stretching and recoiling, the crosslinks act to preserve the topology of the linked siloxane chains in the coating, such that the coating returns to its original shape prior to the particle impact. This chain recoiling accounts for the elastic nature of the coating. The processes of chain stretching, recoil, and interchain friction are also believed to be responsible for the conversion of vibrational energy to thermal energy.

A unique aspect of the invention is the inclusion of acetoxylated silanes in addition to alkoxylated silanes in the composition. The acetoxylated silanes are believed to react with trialkoxylated silanes and tetraalkoxylated silanes to form T- and Q-resins, respectively. A T- or a Q-resin is thought to be a highly crosslinked molecule: the basic structural unit in a T-resin should be a silicon atom bonded to three oxygen atoms, and the basic structural unit in a Q-resin should be a silicon atom bonded to four oxygen atoms. TQ-resins, in which there is a mixture of silicon atoms bonded to three oxygen atoms and silicon atoms bonded to four oxygen atoms, may also be formed. The acetoxylated silanes are believed to react with alkoxylated silanes in the presence of a catalyst even in the absence of moisture such that the T-, Q-, or TQ-resins form when the uncured composition is prepared under anhydrous conditions. When acetoxy groups are in molar excess of alkoxy groups in the composition, the T-, Q-, or TQ-resin molecules have unreacted acetoxy groups on their exterior. When alkoxy groups are in molar excess of acetoxy groups in the composition, the T-, Q-, or TQ-resin molecules have unreacted alkoxy groups on their exterior.

When acetoxy groups are in molar excess of alkoxy groups in the composition, the hydroxy groups on the silanol chains are believed to react with the acetoxy groups to form acetoxylated siloxane chains. Acetic acid is formed and the acetoxylated silane, having lost one acetoxy group, replaces the hydroxy group on the silanol. When no water is present, essentially no further reaction between the acetoxylated siloxane chains and the acetoxylated T-, Q-, or TQ-resins is understood to take place. However, when the coating composition is exposed to water, e.g., when the coating composition is applied to a substrate and has contact with moisture in the air, further reaction can take place. The water reacts with the acetoxy groups to form acetic acid and replace the acetoxy group with a hydroxy group. The acetoxy groups on the siloxane chains and on the T-, Q-, or TQ-resins can then react with hydroxy groups on the siloxane chains and on the T-, Q-, or TQ-resins to release acetic acid and form a bond between siloxane chains and T-, Q-, or TQ-resins, between siloxane chains, or between T-, Q-, or TQ-resins. Because a T-, Q-, or TQ-resin molecule is thought to typically contain more than three or four acetoxy or hydroxy groups, it can link more than three or four siloxane chains at a given site. This structure may act to increase the crosslinking density, while maintaining the length of the siloxane chains.

When alkoxy groups are in molar excess of acetoxy groups in the composition, the hydroxy groups on the silanol chains are believed to react with the alkoxy groups to form alkoxylated siloxane chains. An alcohol is formed and the alkoxylated silane, having lost one alkoxy group, replaces the hydroxy group on the silanol. When no water is present, essentially no further reaction between the alkoxylated siloxane chains and the alkoxylated T-, Q-, or TQ-resins is understood to take place. However, when the coating composition is exposed to water, e.g., when the coating composition is applied to a substrate and has contact with moisture in the air, further reaction can take place. The water reacts with the alkoxy groups to form an alcohol and replace the alkoxy group with a hydroxy group. The alkoxy groups on the siloxane chains and on the T-, Q-, or TQ-resins can then react with hydroxy groups on the siloxane chains and on the T-, Q-, or TQ-resins to release an alcohol and form a bond between siloxane chains and T-, Q-, or TQ-resins, between siloxane chains, or between T-, Q-, or TQ-resins. Because a T-, Q-, or TQ-resin molecule is thought to typically contain more than three or four alkoxy or hydroxy groups, it can link more than three or four siloxane chains at a given site. This structure may act to increase the crosslinking density, while maintaining the length of the siloxane chains.

It is believed that either the acetoxy groups should be in molar excess of alkoxy groups in the composition or the alkoxy groups should be in molar excess of acetoxy groups in the composition. Then, when the components of the composition are mixed, the siloxane chains and the T-, Q-, or TQ-resin molecules are either alkoxylated or they are acetoxylated so that the composition remains liquid and no further reaction takes place until the composition is exposed to water, e.g., moisture in the air. However, when acetoxy groups are in molar excess of alkoxy groups in the composition, and the siloxane chains and the T-, Q-, or TQ-resin molecules are understood to be acetoxylated, the crosslinked network of siloxane chains and T-, Q-, or TQ-resin molecules is believed to form more rapidly upon exposure to water, e.g., moisture in the air, than if alkoxy groups were in molar excess of acetoxy groups and the siloxane chains and the T-, Q-, or TQ-resin molecules were alkoxylated.

The present invention includes the use of any acetoxylated silane, alkoxylated silane, and silanol fluid.- Specific components may be selected to control the physical and chemical properties of the coatings formed. In this way, a composition may be tailored to a specific application. For example, it may be possible to achieve an optimal balance between hardness and resiliency of a coating by adjusting the molecular weight of the silanol chains and the fraction of the composition which is acetoxylated silane and the fraction of the composition which is alkoxylated silane. These factors are believed to effect the hardness and resiliency of a coating as follows.

As described above, a coating could dissipate the energy of a particle impact when formed from siloxane chains linked by tri- or tetrafunctional crosslinking agents. However, it is believed that if the kinetic energy of an impacting particle is too high, certain siloxane chains can be stretched and stressed so that they break. With repeated high energy particle impacts, the coating would be degraded such that it would be worn away or no longer be effective in preventing the kinetic energy of a particle impact from being transmitted to the substrate. By increasing the density of crosslinks, e.g., by using lower molecular weight silanol chains and a greater concentration of crosslinking agent, the stress associated with a particle impact could be distributed over a larger number of siloxane chains, such that the impact energy threshold for substantial chain breakage would be increased. However, because the chains would be shorter, they could not stretch as far and the coating would be harder. Although a harder coating may be useful for certain applications, the harder coatings would be expected to transmit more vibrational energy associated with cavitation or particle impact to the substrate than a coating with a lower crosslinking density. The coating would be more brittle, and could be chipped off near to the surface. The coating could also impede flexing of a substrate, such as a helicopter rotor. By contrast, because the T-, Q-, or TQ-resins link together many siloxane chains at a single point, the stress associated with a particle impact is more effectively distributed from a given chain to many other chains than if tri- or tetrafunctional crosslinking agents were exclusively used. At the same time, because the silanol chains are not shortened, the coating is resilient, not brittle, and can effectively dissipate kinetic and vibrational energy so that the underlying substrate is not damaged.

After the components of the composition are mixed, the initial set of reactions described above, for example, the formation of the T-, Q-, and TQ-resins described above, is believed to occur under dry conditions. However, bonding of individual siloxane chains with other siloxane chains or with T-, Q-, or TQ-resins under these dry conditions is believed not to occur substantially. After mixing of the components, the composition can be immediately applied to a substrate, or the composition can be stored under dry conditions for a waiting period to allow the initial set of reactions to proceed before application. The composition can be stored under dry conditions for an extended duration.

Upon exposure to moisture, for example, when the composition is applied to a substrate and exposed to the air, it is believed that the acetoxylated siloxane or alkoxylated siloxane chains bond with other siloxane chains, the acetoxylated or alkoxylated silanes, or the T-, Q-, or TQ-resins to form a crosslinked network. That is, upon exposure to moisture in the air, the composition cures to form a silicone coating. There is no need for artificially-generated heat to be applied in order to effect cure.

Curing agents can be formed separately from the rest of the composition and then added back to the composition. The curing agents are thought to consist of T-, Q-, or TQ-resins and are termed T-, Q-, or TQ-resin curing agents, respectively. A T-resin curing agent is formed by reacting a triacetoxysilane with a trialkoxysilane. A Q-resin curing agent is formed by reacting a triacetoxysilane with a tetraalkoxysilane. As used herein, a TQ-resin refers to a resin with trifunctional silane units, tetrafunctional silane units, or a combination thereof. A TQ-resin curing agent can be formed by reacting a triacetoxysilane with both a trialkoxysilane and a tetraalkoxysilane. In an embodiment, the reaction is conducted with acetoxy groups in molar excess of alkoxy groups. In this embodiment, the curing agent is thought to contain unreacted acetoxy groups. In an alternative embodiment, the reaction is conducted with alkoxy groups in molar excess of acetoxy groups. In this embodiment, the curing agent is thought to contain unreacted alkoxy groups. The reaction to form a curing agent can proceed without a catalyst, or with a catalyst, e.g., dibutyl tin dilaurate, to speed up the reaction.

The curing agent can include the components with fraction ranges shown in Table 11.

TABLE 11

| Component | Fraction Range |
|---|---|
| Acetoxylated silane | 5-95 wt. % |
| Alkoxylated silane | 5-95 wt. % |
| Catalyst | 0.01-15 wt. % |

Typically, the curing agent composition contains acetoxy groups in molar excess of alkoxy groups or alkoxy groups in molar excess of acetoxy groups.

Curing agent compositions can include fractions of components in the ranges shown in Table 12.

TABLE 12

| Component | Fraction Range |
|---|---|
| Acetoxylated silane | 52-80 wt. % |
| Alkoxylated silane | 20-45 wt. % |
| Catalyst | 1-10 wt. % |

Other curing agent compositions can include fractions of components in the ranges shown in Table 13.

TABLE 13

| Component | Fraction Range |
|---|---|
| Acetoxylated silane | 20-45 wt. % |
| Alkoxylated silane | 52-80 wt. % |
| Catalyst | 1-10 wt. % |

Exemplary curing agent compositions can include the fractions of components in the ranges shown in Table 14.

TABLE 14

| Component | Fraction Range |
|---|---|
| Acetoxylated silane | 52-65 wt. % |
| Alkoxylated silane | 35-45 wt. % |
| Catalyst | 1-10 wt. % |

In an embodiment, the molar ratio of acetoxylated silane to alkoxylated silane ranges from about 1.5 to 1 to about 8 to 1. In another embodiment, the molar ratio of alkoxylated silane to acetoxylated silane ranges from about 1.5 to 1 to about 8 to 1.

An example of a method of preparing a curing agent composition is as follows. Acetoxylated silane, alkoxylated silane, and catalyst are combined. The combination is then mixed. The mixture is then heated to refluxing. An example of a catalyst is a titanium catalyst.

When a curing agent, e.g., a T-, Q-, or TQ-resin curing agent, is added to a coating composition, it is not necessary to wait as long for reactions to take place in forming a composition which has favorable structure, i.e., which has T-, Q-, or TQ-resin present, for application and cure on a substrate. The T-, Q-, or TQ-resin curing agents are formed ahead of time and can immediately serve as cross-linking sites.

A range of techniques can be used to apply the composition to the substrate, including, for example, spraying the composition onto the substrate, brushing or spreading the composition on the substrate, and dipping the substrate in the composition. The composition can then be cured upon exposure of the composition to moisture in the air, as discussed above.

For certain substrates, application of a primer composition to the substrate and allowance of partial or full cure of the primer composition to form a primer before application of the composition may improve bonding of the cured silicone coating formed to the substrate. The primer composition includes an epoxy blend, an adhesion promoter, and an aliphatic amine. The epoxy blend can include epichlorohydrin and a bisphenol, e.g., Bisphenol-F; for example, EPON® Resin 862 manufactured by Resolution Performance Products LLC is a suitable epoxy blend. The adhesion promoter can be, for example, a trimethoxysilane, a triethoxysilane, or 3-glycidoxypropyltrimethoxysilane. An example of a suitable aliphatic amine is, for example, EPIKURE™ Curing Agent 3218 manufactured by Resolution Performance Products LLC. The adhesion promoter is believed to enhance the chemical bonding of the silicone coating with the primer.

A range of techniques can be used to apply the primer composition to the substrate, including, for example, spraying the primer composition onto the substrate, brushing or spreading the primer composition on the substrate, and dipping the substrate into the primer composition. The primer composition can also include other components, in order to, for example, control viscosity or otherwise facilitate application to the substrate. The primer composition can include, for example, a leveling agent, a solvent, or a pigment. An example of a suitable leveling agent is a modified urea formaldehyde in butanol; for example, CYMEL® U-216-8 resin manufactured by Cytec Industries Inc. A mixture of 2-ethoxyethanol and xylene is an example of a solvent. After the primer composition is applied to the substrate, a period of time is allowed for the primer composition to partially or fully cure to a primer. It is believed that when the composition is applied over the primer, unreacted functional groups in the composition can react with unreacted functional groups in the primer.

Exemplary primer compositions can include fractions of components in the ranges shown in Table 15.

TABLE 15

| Component | Fraction Range |
|---|---|
| Epoxy blend | 20-95 wt. % |
| Adhesion promoter | 0.5-10 wt. % |
| Aliphatic amine | 1-20 wt. % |
| Leveling agent, solvent, or pigment | 0.01-70 wt. % |

An example of a primer composition is provided in Table 16.

TABLE 16

| Component | Fraction |
|---|---|
| EPON ® Resin 862 | 26 wt. % |
| 3-glycidoxypropyltrimethoxysilane | 3.7 wt. % |
| EPIKURE ™ Curing Agent 3218 | 6.8 wt. % |
| CYMEL ® U-216-8 resin | 0.78 wt. % |
| 2-ethoxyethanol | 42 wt. % |
| Xylene | 13.2 wt. % |
| Pigment | 7.8 wt. % |

The coating compositions of the present invention can be formulated such that properties of the coating are balanced to meet the need for dissipation of kinetic energy and vibrational energy associated with particle impact and cavitation in order to protect the substrate and the need for resistance of the coating to erosion. The coatings are resistant to degradation by environmental factors such as water, elevated temperature, and sunlight.

The coatings are suitable for a wide range of uses, of which only a few examples are presented here. The coatings are useful in protecting parts of machines or structures which are exposed to particle impact or cavitation. For example, the coatings are useful for protecting pipes, ducts, or intake manifolds through which a fluid, that is, a gas, e.g., air, or a liquid, e.g., water, passes. For example, the coatings are useful in protecting the air intake ducts or manifolds of combustion engines used in environments were the air is heavily laden with dust or sand, e.g., engines used in mining operations. The coatings may also be useful in protecting the air intake ducts or manifolds of piston or jet aircraft engines.

The coatings are useful in protecting rotational units, such as rotational units which are used in a fluid, that is, a gas, e.g., air, or a liquid, e.g., water, medium. Such rotational units may convert the kinetic energy of the surrounding medium to rotational energy, or may convert rotational energy, i.e., the rotational unit is driven to rotate, to kinetic energy of the surrounding medium, e.g., the rotational unit propels the medium.

An example of a use is protecting turbines with the coating. For example, the water passing through hydroelectric turbines may contain a high concentration of small particles such as silt which impact various parts of the turbine, including turbine blades. Particle impact and cavitation can erode the material of which the turbine is formed. The silicone coatings of the invention protect a substrate, such as turbine blades or other turbine parts, from erosion by particle impact and cavitation. Another example of a use of the coating is in protecting fluid impellers, such as marine propellers, e.g., propellers for marine vehicles, from erosion caused by particle impact and by cavitation. The coatings are essentially unaffected by water, rendering them suitable for applications such as hydroelectric turbines and marine propellers.

Another example of a use is protecting helicopter rotors with the coating. Helicopter rotors may be impacted by large numbers of particles during operation. The particle impact rate may be especially high during take-off and landing and may be especially high during operation in arid or desert environments. Helicopter rotors are impacted by water particles during operation in rain, fog, snow, hail, or other inclement weather. Impact by dust, sand, water and other particles can erode the material of which helicopter rotors are formed. As discussed above, the silicone coatings of the invention protect a substrate from erosion by particle impact and cavitation. The coatings exhibit good resistance to degradation by sunlight and water and therefore are suitable for coating helicopter rotors, on which the coating is exposed to the elements for extended periods of time. The silicone coatings are also resistant to degradation by elevated temperature; such elevated temperature could be reached, for example, during extended exposure to sunlight in equatorial regions. The silicone coatings could also be used in protecting other devices which induce air flow, including aircraft propellers and turbojet fans. Another use of the coatings is in protecting devices which convert air flow to rotational energy, for example, windmills.

The silicone coatings of the invention do not suffer the limitations of approaches known in the art to protect, for example, helicopter rotors against erosion. Unless the energy of impact of a particle is very large, the silicone coatings do not suffer permanent deformation; by contrast, metal sheaths do suffer permanent deformation or chipping. The silicone coatings are believed not to transmit- the vibration associated with particle impact to the substrate; metal sheaths may transmit such vibration. The silicone coatings have long life; by contrast, polyurethane tape has a short service life which may be further reduced by the accumulation of particles, e.g., sand under the tape, requiring replacement of the tape.

In addition to protecting a substrate from erosion by particle impact or cavitation, silicone coatings according to the invention may also provide a barrier which protects a substrate from potentially harmful environmental effects. For example, a silicone coating according to the invention may include a pigment agent which absorbs visible or ultraviolet light and thereby protects a substrate, e.g., the material which forms a helicopter rotor, from degradation by visible or ultraviolet light. The silicone coating of the invention also provides at least a temporary barrier to water, and thereby protects the underlying substrate from at least intermittent exposure to water, for example, a helicopter rotor could be protected from rain or fog.

Use of the coatings to protect substrates is economically favorable. The components of the composition have a low cost and the mixing operation is simple and straightforward. The fractions of components in the coating composition can be adjusted so that the composition is suitable for any one of a range of application methods; these application methods include methods often associated with mass production, e.g., spraying, as well as methods often associated with one-off production, e.g., brushing or spreading. No special heat treatment is required to cure the composition; once applied to the substrate, the composition need only be exposed to the air; even the air in dry climates contains sufficient moisture to induce cure. As a result, costs associated with applying the compositions to a substrate are low. As discussed above, the silicone coatings have a long service life; elimination of the need for frequent replacement further reduces both material and labor costs in comparison with prior art protection methods.

The coating compositions can be coated onto substrates, e.g., a material forming a surface of a part. The coating has been applied to, for example, the following: a metal such as a steel alloy, a stainless steel alloy, an aluminum alloy, a nickel alloy, a titanium alloy, or a lead alloy; a ceramic; a polymer, such as a urethane, an epoxy, a polycarbonate, or an acrylic; polyester composites or epoxy composites; fabric formed of KEVLAR®, a polyaramid with the trademark held by E.I. du Pont de Nemours and Co., polyester fabric, nylon fabric, or vinyl coated fabric; glass; concrete; or wood. The coating composition is expected to be capable of being applied and forming a coating on cotton, pottery material, or brick.

Non-T/Q-resin forming coating compositions are also useful in forming erosion-resistant coatings. A non-T/Q-resin forming coating composition includes a siloxane and a cross-linking agent. The crosslinking agent may be an acetoxylated silane, an alkoxylated silane, or another compound; mixtures of crosslinking agents may be used, however, not both an acetoxylated silane and an alkoxylated silane are included in the mixture. The siloxane chains are linked by the crosslinking agent, but T-, Q-, or TQ-resins are not formed to a substantial extent. The non-T/Q-resin forming coating composition can be applied to a range of substrates through a variety of application techniques including spraying, brushing, spreading, and dipping and cured to form a coating in order to protect the substrate from damage induced by impacting particles or cavitation in the vicinity of the substrate. The range of substrate materials and the range of structural and machine parts discussed above for coatings which do include T-, Q-, or TQ-resins can also be protected by coatings formed from non-T/Q-resin forming coating compositions.

### EXAMPLE 1

Exemplary embodiments of coating compositions are presented in Table 17.

TABLE 17

| | Comp. 1 | Comp. 2 | Comp. 3 | Comp. 4 |
|---|---|---|---|---|
| | Fraction | Fraction | Fraction | Fraction |
| Component | wt. % | wt. % | wt. % | wt. % |
| Ethyltriacetoxysilane | 2.7 | 2.5 | 1.44 | 2 |
| Vinyltriacetoxysilane | 2.6 | 0 | 1.43 | 2 |
| Vinyltriethoxysilane | 0.72 | 0.51 | 0.58 | 0.83 |
| Tetraethoxysilane | 2.4 | 0 | 0 | 0 |
| Silanol fluid | 42 | 29 | 34 | 48 |
| (50,000 cSt) | | | | |
| Trimethyl terminated | 3.2 | 2.2 | 2.6 | 3.7 |
| polydimethylsiloxane | | | | |
| Dibutyl tin dilaurate | 0.050 | 0.037 | 0.042 | 0.060 |
| Xylene | 44 | 60 | 52 | 28 |
| Fumed silica | 2.3 | 5.2 | 4.6 | 6.5 |
| Mica | 0 | 0 | 3.1 | 0 |
| Glass fiber | 0 | 0 | 0 | 8.7 |

Composition 1 was cured to form a soft coating. Composition 2 was cured to form a coating of intermediate hardness. Composition 3 included mica as a filler; the mica particles used had a largest dimension of less than about 40 microns. Composition 4 included glass fiber as a filler; the glass fibers had a typical length of about 1 millimeter.

### EXAMPLE 2

The resistance of the erosion-resistant silicone coating according to the invention to erosion by impacting particles was compared with that of several other materials. Each material was blasted with 120 grit alumina having an impact velocity of 60 m/s. Tests were performed with a grit impact angle of 90° with the material surface and with a grit impact angle of 30° with the material surface. The erosion rate is presented in Table 18 in terms of the mass of the eroded material (in micrograms) per mass of grit which has impinged (in grams).

TABLE 18

| | Erosion Rate at | Erosion Rate at |
|---|---|---|
| | 30° Impact Angle | 90° Impact Angle |
| Material | in μgₘₐₜₑᵣᵢₐₗ/g_{grit} | in μgₘₐₜₑᵣᵢₐₗ/g_{grit} |
| Glass-Fiber Reinforced Epoxy | 104 | 74 |
| Aluminum | 41 | 14.9 |
| Nickel | 63 | 37 |
| 1010 Steel | 61 | 36 |
| Stainless Steel | 56 | 38 |
| Polyurethane Tape | 11.6 | 1.3 |
| Erosion-Resistant Silicone Coating | 2.7 | 1.0 |
| according to the invention | | |

Table 18 illustrates that under these test conditions, the erosion rate of the erosion-resistant silicone coating according to the invention is less than that of any other material tested.

### EXAMPLE 3

The resistance of the erosion-resistant silicone coating according to the invention to erosion by sonication was compared with that of several other materials. Sonication is used because its effects may resemble the effects of cavitation. Each material was exposed to sound at 20 kHz with a flux of 41 W/cm². The erosion rate is presented in Table 19 in terms of the mass of the eroded material (in milligrams) per time of sonication (in hours).

TABLE 19

| | Erosion rate |
|---|---|
| Material | in mgₘₐₜₑᵣᵢₐₗ/hr |
| Glass-Fiber Reinforced Epoxy | 6.0 |
| Aluminum | 39 |
| Nickel | 10.5 |
| 1010 Steel | 10 |
| Stainless Steel | 3.3 |
| Polyurethane Tape | —* |
| Erosion-Resistant Silicone Coating | 1.0 |
| according to the invention | |

*When exposed to sonication, the polyurethane tape was found to blister and deadhere from the surface to which it was affixed. This behavior precluded the accurate determination of the erosion rate of the polyurethane tape.

Table 19 illustrates that under these test conditions, the erosion rate of the erosion-resistant silicone coating according to the invention is less than that of any other material tested.

### EXAMPLE 4

An example of a curing agent composition which reacts to form a T-resin curing agent is provided in Table 20.

TABLE 20

| Component | Fraction |
|---|---|
| Ethyltriacetoxysilane | 52 wt. % |
| Vinyltriethoxysilane | 44 wt. % |
| Dibutyl tin dilaurate | 3.2 wt. % |

### EXAMPLE 5

An example of a non-T or Q-resin coating composition is presented in Table 21.

TABLE 21

| | Fraction |
|---|---|
| Component | wt. % |
| Ethyltriacetoxysilane | 2.1 |
| Silanol fluid | 40 |
| (50,000 cSt) | |
| Dibutyl tin dilaurate | 0.050 |
| Xylene | 54 |
| Fumed silica | 3.8 |

The composition was cured to form a soft coating.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A coating composition for an erosion-resistant coating, comprising:
an acetoxylated silane in an amount of from about 0.01 wt. % to about 95 wt. % of the composition;
an alkoxylated silane in an amount of from about 0.01 wt. % to about 95 wt. % of the composition; and,
a silanol fluid in an amount of from about 1 wt. % to about 95 wt. % of the composition.

2. The coating composition of claim 1, the acetoxylated silane being in molar excess of the alkoxylated silane or the alkoxylated silane being in molar excess of the acetoxylated silane.

3. The coating composition of claim 1, wherein the silanol fluid, in an essentially pure state, has a kinematic viscosity of from about 10,000 centistokes to about 50,000 centistokes.

4. The coating composition of claim 1, wherein the silanol fluid comprises a hydroxy-terminated polydimethylsiloxane.

5. The coating composition of claim 1, wherein the acetoxylated silane comprises an alkyl or alkenyltriacetoxysilane, wherein the alkyl or alkenyl moieties comprise more than one carbon atom.

6. The coating composition of claim 5, wherein the acetoxylated silane is selected from the group consisting of ethyltriacetoxysilane and vinyltriacetoxysilane.

7. The coating composition of claim 1, wherein the alkoxylated silane is selected from the group consisting of alkyltrialkoxysilane, alkenyltrialkoxysilane, and tetraalkoxysilane.

8. The coating composition of claim 7, wherein the alkoxylated silane is selected from the group consisting of ethyltriethoxysilane, vinyltriethoxysilane, tetramethoxysilane, and tetraethoxysilane.

9. The coating composition of claim 1, further comprising at least one additional component selected from a catalyst, a filler, a solvent, a pigment agent, and a curing agent.

10. The coating composition of claim 9 1, wherein the further comprising a catalyst that comprises dibutyl tin dilaurate.

11. The coating composition of claim 1, further comprising a filler is selected from the group consisting of fumed silica, mica, and glass fiber.

12. The coating composition of claim 1, further comprising a fumed silica that has been treated with a silica treatment agent selected from the group consisting of hexamethylenedisilazane, divinyltetramethylenedisilazane, chlorosilane, and polydimethylsiloxane.

13. The coating composition of claim 1, further comprising a filler that comprises particles of high aspect ratio.

14. The coating composition of claim 1, further comprising a curing agent comprising a reaction product of an acetoxylated silane and an alkoxylated silane.

15. The coating composition of claim 14, wherein the curing agent comprises a reaction product of ethyltriacetoxysilane and vinyltriethoxysilane.

16. The coating composition of claim 1, further comprising:
trimethyl terminated polydimethylsiloxane in an amount of from about 0.01 wt. % to about 30 wt. % of the composition;
catalyst in an amount of from about 0.005 wt. % to about 2 wt. % of the composition; fumed silica in an amount of from 0.01 wt. % to about 30 wt. % of the composition; and
mica or glass fiber in an amount of from about 0.01 wt. % to about 50 wt. % of the composition.

17. The coating composition of claim 1, wherein:
the acetoxylated silane comprises from about 0.5 wt. % to about 8 wt. % of the composition;
the alkoxylated silane comprises from about 0.1 wt. % to about 4 wt. % of the composition; and,
the silanol fluid comprises from about 40 wt. % to about 92 wt. % of the composition; and further comprising
fumed silica in an amount of from about 2 wt. % to about 20 wt. % of the composition.

18. The coating composition of claim 17, further comprising:
trimethyl terminated polydimethylsiloxane in an amount of from about 1 wt. % to about 4 wt. % of the composition;
catalyst in an amount of from about 0.04 wt. % to about 1 wt. % of the composition; and,
mica or glass fiber in an amount of from about 0.01 wt. % to about 50 wt. % of the composition.

19. The coating composition of claim 1, wherein:
the acetoxylated silane comprises ethyltriacetoxysilane in an amount of from about 1 wt. % to about 3 wt. % of the composition;
the alkoxylated silane comprises vinyltriethoxysilane in an amount of from about 0.1 wt. % to about 1.5 wt. % of the composition; and
the silanol fluid comprises from about 40 wt. % to about 80 wt. % of the composition; and wherein the coating composition further comprises
trimethyl terminated polydimethylsiloxane in an amount of from about 2 wt. % to about 4 wt. %,
catalyst in an amount of from about 0.04 wt. % to about 0.08 wt. %, and
fumed silica in an amount of from about 2 wt. % to about 10 wt. %.

20. The coating composition of claim 19, fuirther comprising:
vinyltriacetoxysilane in an amount of from about 0.01 wt. % to about 3 wt. % of the composition;
tetraethoxysilane in an amount of from about 0.01 wt. % to about 3 wt. % of the composition;
solvent in an amount of from about 10 wt. % to about 60 wt. % of the composition; and,
mica, glass fiber, or a combination thereof in an amount of from about 0.01 wt. % to about 50 wt. % of the composition.

21. The coating composition of claim 1, wherein:
the molar ratio of acetoxylated silane to silanol is from about 10 to 1 to about 1000 to 1; and,
the molar ratio of acetoxylated silane to alkoxylated silane is from about 1.5 to 1 to about 8 to 1.

22. The coating composition of claim 21, wherein:
the molar ratio of acetoxylated silane to silanol is from about 20 to 1 to about 250 to 1; and,
the molar ratio of acetoxylated silane to alkoxylated silane is from about 1.5 to 1 to about 8 to 1.

23. The coating composition of claim 1, wherein:
the molar ratio of alkoxylated silane to silanol is from about 10 to 1 to about 1000 to 1; and,
the molar ratio of alkoxylated silane to acetoxylated silane is from about 1.5 to 1 to about 8 to 1.

24. The coating composition of claim 23, wherein:
the molar ratio of alkoxylated silane to silanol is from about 20 to 1 to about 250 to 1; and,
the molar ratio of alkoxylated silane to acetoxylated silane is from about 1.5 to 1 to about 8 to 1.

25. A method of preparing a coating composition for an erosion-resistant coating, comprising:
providing an acetoxylated silane;
providing an alkoxylated silane;
providing a silanol fluid; and,
combining the acetoxylated silane, the alkoxylated silane, and the silanol fluid in any order and mixing.

26. The method of preparing a coating composition of claim 25, wherein the silanol fluid, in an essentially pure state, has a kinematic viscosity of from about 10,000 centistokes to about 50,000 centistokes.

27. The method of preparing a coating composition of claim 25, wherein the silanol fluid comprises a hydroxy-terminated polydimethylsiloxane.

28. The method of preparing a coating composition of claim 25, wherein the acetoxylated silane is selected from the group consisting of ethyltriacetoxysilane and vinyltriacetoxysilane.

29. The method of preparing a coating composition of claim 25, wherein the alkoxylated silane is selected from the group consisting of ethyltriethoxysilane, vinyltriethoxysilane, tetramethoxysilane, and tetraethoxysilane.

30. The method of preparing a coating composition of claim 25, further comprising:
providing a filler selected from the group consisting of fumed silica treated with a silica treatment agent selected from the group consisting of hexamethylenedisilazane, divinyltetramethylenedisilazane, chlorosilane, and polydimethylsiloxane; mica; and glass fiber; and,
combining the filler with the coating composition and mixing.

31. The method of preparing a coating composition of claim 25, further comprising:
providing a curing agent; and,
combining the curing agent with the coating composition and mixing.

32. The method of preparing a coating composition of claim 31, wherein the curing agent comprises a reaction product of ethyltriacetoxysilane, vinyltriethoxysilane, and dibutyl tin dilaurate.

33. A method for coating a substrate with an erosion-resistant coating, comprising the steps of:
preparing a coating composition for an erosion-resistant coating comprising an acetoxylated silane, an alkoxylated silane, and a silanol fluid;
applying the coating composition to the substrate; and,
curing the coating composition on the substrate.

34. The method for coating a substrate with an erosion-resistant coating of claim 33, the applying selected from spraying, spreading, brushing, and dipping.

35. The method for coating a substrate with an erosion-resistant coating of claim 33, wherein curing comprises curing the coating composition in air without artificially-generated heat.

36. The method for coating a substrate with an erosion-resistant coating of claim 33, further comprising waiting for a period of at least two days after preparing the coating composition and before applying the coating composition to the substrate.

37. The method for coating a substrate of claim 33, further comprising:
preparing a primer composition comprising an epoxy blend, an adhesion promoter, and an aliphatic amine;
applying the primer composition to the substrate; and,
at least partially curing the primer composition on the substrate before applying the coating composition to the substrate.

38. The method for coating a substrate of claim 37, wherein the adhesion promoter is selected from the group consisting of a trimethoxysilane, a triethoxysilane, and 3-glycidoxypropyltrimethoxysilane.

39. The method for coating a substrate of claim 37, wherein the primer composition further comprises a leveling agent and a solvent.

40. A method for using an erosion-resistant coating, comprising:
preparing a coating composition according to claim 1;
applying the coating composition to a part; and,
curing the coating composition.

41. The method for using an erosion-resistant coating of claim 40, wherein the part comprises a pipe, a duct, or an intake manifold.

42. The method for using an erosion-resistant coating of claim 40, wherein the part comprises a rotational unit.

43. The method for using an erosion-resistant coating of claim 42, wherein the rotational unit is selected from the group consisting of a windmill, a turbine, a helicopter rotor, an aircraft propeller, a turbojet fan, and a marine propeller.

44. (currently amended): The method for using an erosion-resistant coating of claim 40, wherein a material forming a surface of a part is selected from the group consisting of a metal, a ceramic, of and a polymer.

45. The method for using an erosion-resistant coating of claim 34, wherein a material forming a surface of a part is selected from the group consisting of a steel alloy, a stainless steel alloy, an aluminum alloy, a nickel alloy, a titanium alloy, a lead alloy, a urethane, an epoxy, a polycarbonate, an acrylic, polyester composites, epoxy composites, polyaramid fabric, polyester fabric, nylon fabric, vinyl coated fabric, glass, concrete, wood, cotton, pottery material, and brick.

46. A curing agent composition, comprising:
an acetoxylated silane; and,
an alkoxylated silane.

47. The curing agent composition of claim 46, wherein the acetoxylated silane comprises an alkyl or alkenyltriacetoxysilane having alkyl or alkenyl moieties comprising more than one carbon atom.

48. The curing agent composition of claim 47, wherein the acetoxylated silane is selected from the group consisting of ethyltriacetoxysilane and vinyltriacetoxysilane.

49. The curing agent composition of claim 46, wherein the alkoxylated silane is selected from the group consisting of alkyltrialkoxysilane, alkenyltrialkoxysilane, and tetraalkoxysilane.

50. The curing agent composition of claim 49, wherein the alkoxylated silane is selected from the group consisting of ethyltriethoxysilane, vinyltriethoxysilane, tetramethoxysilane, and tetraethoxysilane.

51. A method of preparing a curing agent composition, comprising:
providing an acetoxylated silane;
providing an alkoxylated silane;
providing a catalyst;
combining the acetoxylated silane, the alkoxylated silane, and the catalyst in any order, mixing, and refluxing.

52. A method for using an erosion-resistant coating, comprising:
preparing a non-T/Q-resin forming coating composition comprising a siloxane and a crosslinking agent;
applying the composition to a part; and,
curing the composition,
wherein the cured composition is substantially free of T-, Q-, or TQ-resins.

53. The method for using an erosion-resistant coating of claim 52, wherein the part comprises a pipe, a duct, or an intake manifold.

54. The method for using an erosion-resistant coating of claim 52, wherein the part comprises a rotational unit.

55. (new): The method for using an erosion-resistant coating of claim 40, wherein the part comprises a hydroelectric turbine.

56. The method for using an erosion-resistant coating of claim 55, wherein the part is a blade of a hydroelectric turbine.

57. An erosion-resistant part comprising:
a coating composition according to claim 1; and,
a surface of the part, wherein,
said coating composition is cured on said surface of the part and a material forming said surface of the part is selected from the group consisting of a metal, a ceramic, a polymer, a steel alloy, a stainless steel alloy, an aluminum alloy, a nickel alloy, a titanium alloy, a lead alloy, a urethane, an epoxy, a polycarbonate, an acrylic, polyester composites, epoxy composites, polyaramid fabric, polyester fabric, nylon fabric, vinyl coated fabric, glass, concrete, wood, cotton, pottery material, and brick.

58. An erosion-resistant part comprising:
a coating composition according to claim 1; and,
a surface of the part, wherein,
said coating composition is cured on said surface of the part and a material forming said surface of the part is a steel alloy or a stainless steel alloy.

59. An erosion-resistant part comprising
a coating composition according to claim 1 cured on a surface of the part, wherein
the part is selected from the group consisting of a pipe, a duct, an intake manifold, a windmill, a turbine, a helicopter rotor, an aircraft propeller, a turbojet fan, a marine propeller, a hydroelectric turbine, and a blade of a hydroelectric turbine.

60. An erosion-resistant part comprising
a coating composition according to claim 1 cured on a surface of the part, wherein the part is a hydroelectric turbine.

61. An erosion-resistant part comprising
a coating composition according to claim 1 cured on a surface of the part, wherein the part is a blade of a hydroelectric turbine.
Page 12 of 13
